(19) United States
(12) Patent Application Publication
(10) Pub. No.: US 2024/0222675 A1
(43) Pub. Date: Jul. 4, 2024

(54) SALT CAVERN FLOW BATTERY SYSTEM

(71) Applicant: INSTITUTE OF ROCK AND SOIL MECHANICS, CHINESE ACADEMY OF SCIENCES, Wuhan City (CN)

(72) Inventors: Xilin SHI, Wuhan City (CN); Si HUANG, Wuhan City (CN); Yinping LI, Wuhan City (CN); Hongling MA, Wuhan City (CN); Chunhe YANG, Wuhan City (CN); Peng LI, Wuhan City (CN)

(73) Assignee: INSTITUTE OF ROCK AND SOIL MECHANICS, CHINESE ACADEMY OF SCIENCES, Wuhan City, HU (CN)

(21) Appl. No.: 18/347,529

(22) Filed: Jul. 5, 2023

(30) Foreign Application Priority Data
Dec. 30, 2022 (CN) 202211734270.6

(51) Int. Cl. H01M 8/18; H01M 8/0289; H01M 8/04276

(52) U.S. Cl. CPC H01M 8/188; H01M 8/0289; H01M 8/04276; H01M 2250/10

(57) ABSTRACT

A salt cavern flow battery system includes: stack; salt cavern, including n positive salt caverns for storing a positive electrolyte with different valence states separately, and m negative salt caverns for storing a negative electrolyte with different valence states separately; a first closed loop being formed by connecting the positive electrode of the stack and the n positive salt caverns in series through a pipeline; a second closed loop being formed by connecting the negative electrode of the stack and the m negative salt caverns in series through a pipeline; a first pusher being arranged in the first closed loop to push the positive electrolyte to flow cyclically in the first closed loop, a second pusher being arranged in the second closed loop to push the negative electrolyte to flow cyclically in the second closed loop.

### CROSS-REFERENCE TO RELATED APPLICATIONS

This application claims a priority to Chinese Patent Application No. 202211734270.6, filed on Dec. 30, 2022, the disclosure of which is hereby incorporated by reference in its entirety.

### BACKGROUND

A flow battery with sodium chloride as a supporting electrolyte is an important device for large-scale application of clean and renewable energy. A salt cavern is an artificial underground cavern formed in an underground salt layer by water solution mining. A salt cavern flow battery system uses the salt cavern as a storage tank for an electrolyte, therefore huge costs of land can be saved for such flow battery system.

### SUMMARY

The disclosure relates to a fuel cell and its manufacturing technology, in particular to a salt cavern flow battery system.

Various embodiments of the disclosure provide a salt cavern flow battery system, solving a technical problem of improving an energy density of the salt cavern flow battery system.

The salt cavern flow battery system includes:
a stack, including a positive electrode of the stack and a negative electrode of the stack;
a salt cavern, including n positive salt caverns for storing a positive electrolyte with different valence states separately, and m negative salt caverns for storing a negative electrolyte with different valence states separately, where n and m are positive integers greater than or equal to 2;
a first closed loop formed by connecting the positive electrode of the stack and the n positive salt caverns in series through a pipeline; a second closed loop being formed by connecting the negative electrode of the stack and the m negative salt caverns in series through a pipeline;
a first pusher arranged in the first closed loop to push the positive electrolyte to flow cyclically in the first closed loop; and a second pusher arranged in the second closed loop to push the negative electrolyte to flow cyclically in the second closed loop.

In some embodiments, the first pusher and the second pusher each includes a circulation pump arranged in the pipeline and an isolation medium arranged in the salt caverns.

In some embodiments, a density of the isolation medium is lower than that of the positive electrolyte and the negative electrolyte.

In some embodiments, the isolation medium includes one or more of nitrogen and oil.

In some embodiments, the positive electrolytes include a positive active substance and a sodium chloride supporting electrolyte; the negative electrolytes include a negative active substance and the sodium chloride supporting electrolyte.

In some embodiments, each salt cavern is communicated to the ground through two vertical wells.

In some embodiments, each salt cavern is communicated to the ground by setting a vertical well and an inclined well.

In some embodiments, each salt cavern is communicated to the ground through one vertical well.

In some embodiments, the pipeline is made of corrosion-resistant materials.

In some embodiments, the salt cavern flow battery system is connected with a power supply device for providing electric energy to the salt cavern flow battery system.

One or more technical schemes in the embodiments of the present disclosure have at least the following technical effects or advantages:

The salt cavern flow battery system provided in the embodiments of the present disclosure includes: a stack, including a positive electrode of the stack and a negative electrode of the stack; a salt cavern, including n positive salt caverns for storing a positive electrolyte with different valence states separately; and m negative salt caverns for storing a negative electrolyte with different valence states separately; where n and m are positive integers greater than or equal to 2; a first closed loop being formed by connecting the positive electrode of the stack and the n positive salt caverns in series through a pipeline; a second closed loop being formed by connecting the negative electrode of the stack and the m negative salt caverns in series through a pipeline; a first pusher being arranged in the first closed loop to push the positive electrolyte to flow cyclically in the first closed loop, a second pusher being arranged in the second closed loop to push the negative electrolyte to flow cyclically in the second closed loop. According to the present disclosure, the positive electrode of the stack and the negative electrode of the stack each are connected with two or more salt caverns respectively for storing an electrolyte generated before and after a chemical reaction, so as to obtain a high-concentration oxidation product produced by the positive electrode of the stack and a high-concentration reduction product produced by the negative electrode of the stack during a charging process of the stack, so that an efficiency of an oxidation reaction and a reduction reaction can be improved during a discharge process of the stack, and thus a technical effect of improving a charging energy density of the salt cavern flow battery system can be realized.

### BRIEF DESCRIPTION OF THE DRAWINGS

Various other advantages and benefits will be clearer to those skilled in the art by reading the detailed description of the exemplary embodiments in the following. The accompanying drawings are simply used to illustrate the exemplary embodiments rather than restricting the present disclosure. Through all the drawings, the same reference symbols refer to the same element. In the drawings:

FIG. 1 is a structural diagram of a salt cavern flow battery system according to some embodiments of the present disclosure;

FIG. 2 is a structural diagram of a salt cavern flow battery system according to some other embodiments of the present disclosure; and

FIG. 3 is a structural diagram of a salt cavern flow battery system according to some further embodiments of the present disclosure.

### DETAILED DESCRIPTION

The exemplary embodiments of the disclosure will be described in detail with reference to the accompanying drawings. Although the exemplary embodiments are shown in the drawings, it should be understood that the present disclosure can be implemented in various forms rather than and is not limited to the embodiments described herein. Instead, these embodiments are provided to enable a more thorough understanding of this disclosure and to convey the full scope of this disclosure to those skilled in the art.

The inventors of the present disclosure have recognized that, due to a huge volume of the salt cavern, a concentration distribution of a high-valence state active substance produced by a positive electrode and a low-valence state active substance produced by a negative electrode is extremely uneven in the salt cavern during a charging of the salt cavern flow battery system, which in turn leads to a low energy density of the salt cavern flow battery system during a discharge, thus a requirement of a power consuming side cannot be met.

Various embodiments of the present disclosure can improve the energy density of the salt cavern flow battery system.

### First Embodiment

The technical problem of improving an energy density of a salt cavern flow battery system is solved by the salt cavern flow battery system according to some embodiments of the disclosure.

To solve the above technical problem, the salt cavern flow battery system provided by some embodiments may include:

A stack, provided with a positive electrode of the stack and a negative electrode of the stack. The stack is a device which provides an electrolyte for an electrochemical reaction and changes a valence state of the electrolyte entering the stack. In some embodiments, the stack is arranged on the ground.

The salt cavern flow battery system may further include a salt cavern, including n positive salt caverns for storing a positive electrolyte with different valence states separately; and m negative salt caverns for storing a negative electrolyte with different valence states separately; where n and m are positive integers greater than or equal to 2. In some embodiments, n and m may be both set to be 2. In some embodiments, n and m are determined according to an actual usage requirement and a capacity of a salt cavern actually used, which are not limited herein.

A first closed loop may be formed by connecting the positive electrode of the stack and 2 positive salt caverns in series through a pipeline. A second closed loop may be formed by connecting the negative electrode of the stack and 2 negative salt caverns in series through a pipeline. A first pusher is arranged in the first closed loop to push the positive electrolyte to flow cyclically in the first closed loop, and a second pusher is arranged in the second closed loop to push the negative electrolyte to flow cyclically in the second closed loop.

In some embodiments, the pipeline includes a transmission pipeline connecting the stack to the salt cavern, and a communication pipeline connecting two positive salt caverns or connecting two negative salt caverns.

The first pusher and the second pusher each include: a circulation pump arranged in the transmission pipeline and an isolation medium arranged in the salt cavern. The circulation pump is arranged on the transmission pipeline to push an electrolyte to flow cyclically in the transmission pipeline. A density of the isolation medium is lower than a density of the positive electrolyte and a density of the negative electrolyte. The isolation medium does not react with the electrolyte. The function of the isolation medium is to push, through the transmission pipeline, the electrolyte in another salt cavern into the transmission pipeline, thereby enabling the electrolyte to reach the stack and reacting in the stack. The transmission pipeline is arranged between the salt caverns in a same stage for a transmission of the isolation medium.

In some embodiments, for two positive salt caverns, one of the positive salt caverns stores a low-valence state positive electrolyte. The low-valence state positive electrolyte includes a positive active substance and a sodium chloride (NaCl) supporting electrolyte. The low-valence state positive electrolyte passes through the transmission pipeline into the stack and undergoes an oxidation reaction to produce a high-valence state positive electrolyte. The high-valence state positive electrolyte passes through the transmission pipeline into another positive salt cavern.

Similarly, for two negative salt caverns, one of the negative salt caverns stores a high-valence state negative electrolyte. The high-valence state negative electrolyte includes a negative active substance and the sodium chloride (NaCl) supporting electrolyte. The high-valence state negative electrolyte passes through the transmission pipeline into the stack and undergoes a reduction reaction to produce a low-valence state negative electrolyte. The low-valence state negative electrolyte passes through the transmission pipeline into another negative salt cavern.

The salt cavern flow battery system obtains an electrical energy required by the salt cavern flow battery system by a power supply device connected to the stack. The power supply device used in some embodiments include a power grid, the power grid being used to control an output voltage, and deliver and distribute the electric energy to the stack.

In order to better understand the above technical solution, it will be described in detail in the following with reference to the drawings of the specification and the specific embodiments.

First of all, the term “and/or” in this disclosure is simply to describe the relationship between the associated objects, indicating that there can be three relationships; for example, A and/or B, can indicate three conditions: there is A alone, there are A and B, and there is B alone. In addition, the symbol “/” in this disclosure generally indicates that the associated objects is a “or” relationship.

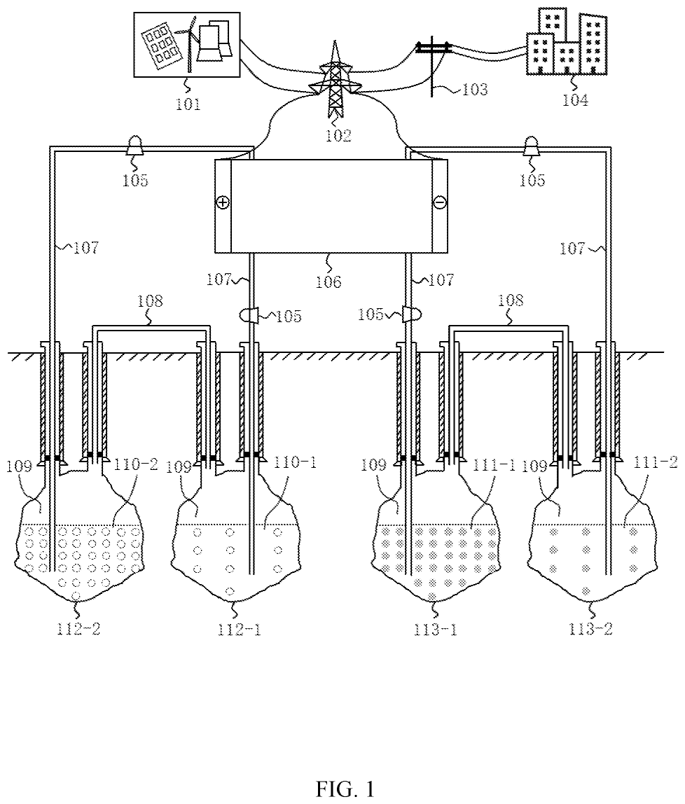

FIG. 1 is a structural diagram of a salt cavern flow battery system according to some embodiments of the present disclosure. As shown in FIG. 1, when the power supply device 101 outputs the electrical energy, the electrical energy is transmitted through the grid 102 into the stack 106. At this time, the salt cavern flow battery system is in a charged state. At a positive electrode of the stack, a low-valence state positive electrolyte 110-1 in the low-valence state positive electrolyte salt cavern 112-1 is delivered by a circulation pump 105 through a transmission pipeline 107 into the stack 106 to undergo an oxidation reaction to produce a high-valence state positive electrolyte 110-2. The circulation pump 105 then delivers the high-valence state positive electrolyte 110-2 through a transmission pipeline 107 to a high-valence state positive electrolyte salt cavern 112-2 for storage. With an entry of the high-valence state positive electrolyte 110-2, an isolation medium 109 in the high-valence state positive electrolyte salt cavern 112-2 will be squeezed through a communication pipeline 108 into the low-valence state positive electrolyte salt cavern 112-1, so that the low-valence state positive electrolyte 110-1 flows again through the transmission pipeline 107 into the stack 106, and the oxidation reaction occurs continuously to generate the high-valence state positive electrolyte 110-2, which is repeated cyclically. Similarly, at a negative electrode of the stack, a high-valence state negative electrolyte 111-1 in a high-valence state negative electrolyte salt cavern 113-1 is delivered by the circulation pump 105 through the transmission pipeline 107 into the stack 106 to undergo a reduction reaction to produce a low-valence state negative electrolyte 111-2. The circulation pump 105 then delivers the low-valence state negative electrolyte 111-2 through the transmission pipeline 107 to a low-valence state negative electrolyte salt cavern 113-2 for storage. With an entry of the low-valence state negative electrolyte 111-2, an isolation medium 109 in the low-valence state negative electrolyte salt cavern 113-2 will be squeezed through the communication pipeline 108 into the high-valence state negative electrolyte salt cavern 113-1, so that the high-valence state negative electrolyte 111-1 flows again through the transmission pipeline 107 into the stack 106, and the reduction reaction occurs continuously to generate the low-valence state negative electrolyte 111-2, which is repeated cyclically.

When the salt cavern flow battery system is in a discharge state, a flow direction of the electrolyte is opposite to that in the charged state. At the positive electrode of the stack, the high-valence state positive electrolyte 110-2 in the high-valence state positive electrolyte salt cavern 112-2 is delivered by the circulation pump 105 through the transmission pipeline 107 into the stack 106 to undergo the reduction reaction to produce a low-valence state positive electrolyte 110-1. The circulation pump 105 then delivers the low-valence state positive electrolyte 110-1 through the transmission pipeline 107 to the low-valence state positive electrolyte salt cavern 112-1. With an entry of the low-valence state positive electrolyte 110-1, the isolation medium 109 in the low-valence state positive electrolyte salt cavern 112-1 will be squeezed through the communication pipeline 108 into the high-valence state positive electrolyte salt cavern 112-2, so that the high-valence state positive electrolyte 110-2 flows again through the transmission pipeline 107 into the stack 106, and the reduction reaction occurs continuously to generate the low-valence state positive electrolyte 110-1, which is repeated cyclically. Similarly, at the negative electrode of the stack, the low-valence state negative electrolyte 111-2 in the low-valence state negative electrolyte salt cavern 113-2 is delivered by the circulation pump 105 through the transmission pipeline 107 into the stack 106 to undergo the oxidation reaction to produce the high-valence state negative electrolyte 111-1. The circulation pump 105 then delivers the high-valence state negative electrolyte 111-1 through the transmission pipeline 107 into the high-valence state negative electrolyte salt cavern 113-1. With an entry of the high-valence state negative electrolyte 111-1, the isolation medium 109 in the high-valence state negative electrolyte salt cavern 113-1 will be squeezed through the communication pipeline 108 into the low-valence state negative electrolyte salt cavern 113-2, so that the low-valence state negative electrolyte 111-2 flows again through a transmission pipeline 107 into the stack 106, and the oxidation reaction occurs continuously to generate the high-valence state negative electrolyte 111-1, which is repeated cyclically.

In some embodiments, sodium chloride (NaCl) solution is a supporting electrolyte for the electrolytes at both the positive electrode and negative electrode of the stack. Materials of the transmission pipeline 107 and the communication pipeline 108 should have certain corrosion resistance. The isolation medium 109 is usually nitrogen gas or oil, which is used to isolate the electrolytes with different valence states, and to push the electrolytes with different valence states into the transmission pipeline 107. The isolation medium 109 has a density lower than that of the electrolytes, does not affect electrochemical properties of the electrolyte and does not erode a surrounding rock of the salt cavern. A construction method of the salt caverns is a drilling solution method.

It can be understood that, in the embodiments of the disclosure each of the positive electrode of the stack and the negative electrode of the stack has two salt caverns, but this is only illustrative and does not constitute a limit on the specific number of the salt caverns of each of the positive electrode of the stack and the negative electrode of the stack in the embodiment of the disclosure. When an energy storage time of the salt cavern flow battery system needs to be increased, the number of the salt caverns of each of the positive electrode of the stack and the negative electrode of the stack can be increased to, for example, 4 or 8 or other quantities. In this way, a long-term energy storage can be realized without changing the existing salt cavern flow battery system. A pipe opening of the communication pipeline 108 is located at a top of the salt cavern, and a pipe opening of the transmission pipeline 107 is located at a bottom of the salt cavern.

In some embodiments, each salt cavern is communicated to the ground through two vertical wells. In some embodiments, the two vertical wells are firstly drilled from a surface of the earth to a target salt cavern, and the transmission pipelines 107 are inserted into the two vertical wells of each salt cavern, and then the two vertical wells are communicated by the communication pipeline. This manner is called a double vertical well combined type.

### Second Embodiment

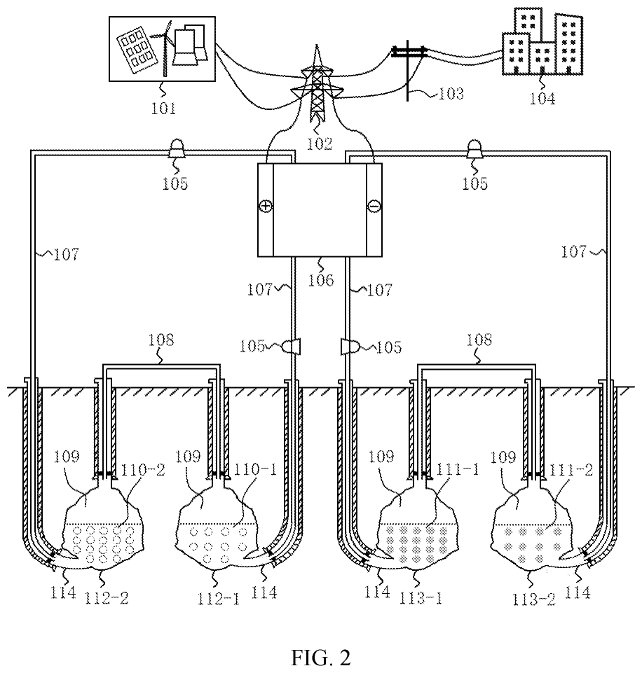

FIG. 2 is a structural diagram of a salt cavern flow battery system according to other embodiments of the present disclosure. A salt cavern flow battery system as shown in FIG. 2 is provided according to some embodiments. Different from the first embodiment, in the salt cavern flow battery system according to FIG. 2, each salt cavern is communicated to the ground by setting a vertical well and an inclined well. In some embodiments, firstly, two wells are drilled from the surface of the earth to reach a target salt cavern, one well is a vertical well and the other well is an inclined well 114. In the target salt cavern, the inclined well 114 is communicated with a bottom of the salt cavern by using a horizontal well directional drilling technology, to realize a communication of the two wells. This manner is called a vertical well and inclined well combined type.

### Third Embodiment

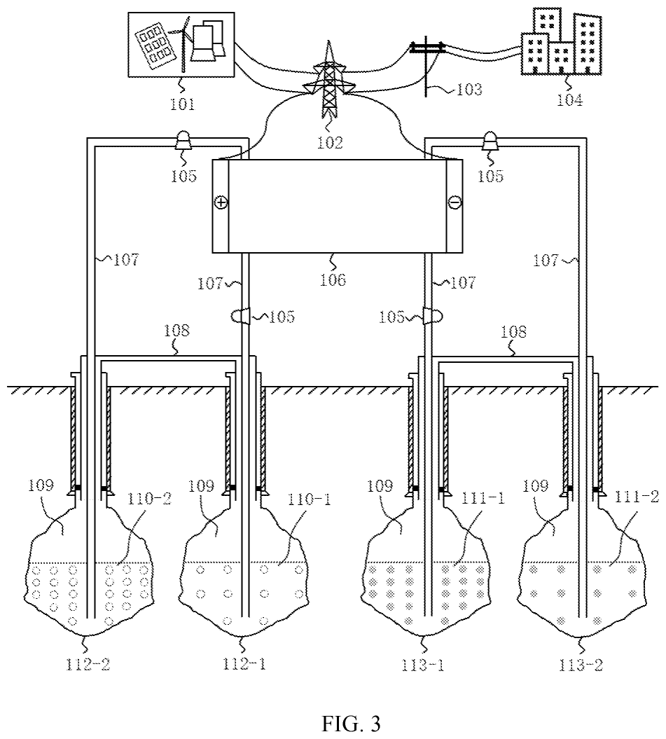

FIG. 3 is a structural diagram of a salt cavern flow battery system according to some further embodiments of the present disclosure. A salt cavern flow battery system as shown in FIG. 3 is different from the salt cavern flow battery systems in FIGS. 1 and 2 in that, each salt cavern is communicated to the ground through one vertical well. In some embodiments, firstly, a vertical well is drilled from the surface of the earth into a target salt cavern, and a multi-layer casing is disposed. This manner is called a single well and multi-layer casing type.

Further, waste salt caverns or salt mine resources can also be transformed according to some embodiments of the present disclosure to meet the requirements of the embodiments of the present disclosure mentioned above, so as to make full use of existing waste salt caverns or salt mine resources.

Technical schemes in one or more embodiments of the present disclosure have at least the following technical effects or advantages: a high-power salt cavern flow battery system is provided according to some embodiments of the present disclosure, by designing and constructing two or more salt caverns at each of the positive electrode of the stack and the negative electrode of the stack to store the electrolytes generated before and after a chemical reaction, a high-concentration oxidation product generated at the positive electrode of the stack and a high-concentration reduction product generated at the negative electrode of the stack can be obtained during a charging process of the stack, so that an efficiency of an oxidation reaction and a reduction reaction can be improved during a discharge process of the stack, and thus a higher energy density of the salt cavern flow battery system can be achieved. Further, since the salt cavern itself contains a saturated sodium chloride (NaCl) solution, the salt cavern flow battery system has unique characteristics of low cost, large capacity and economical land occupation, which is of great significance for a large-scale application of a salt cavern flow battery. The high-power salt-cavern flow battery system provided by the present disclosure can greatly increase concentrations of the oxidation product produced at the positive electrode and the reduction product produced at the negative electrode during the charging process in the salt cavern, so that the energy density of the salt-cavern flow battery system reaches a higher level during the discharge process and can meet requirements of a power consumption side. This will make an important contribution to the large-scale application of the salt cavern flow battery.

The above are only embodiments of this disclosure. A specific structure and features well-known in the art involved in the technical solution have not been described too much here. A person skilled in the art, knowing all general technical knowledge in the technical field of the present disclosure before the application date or the priority date, being able to obtain all existing technologies in the field and having the ability to apply conventional experimental methods before the application date or the priority date, can improve and implement the technical solution of the present disclosure in the light of the present application in combination with their own abilities. Some typical structures or methods well-known in the art should not become obstacles for a person skilled in the art to implement this disclosure. It should be pointed out that for a person skilled in the art, some modifications and improvements can be made without departing from the scope of protection of this disclosure. These modifications and improvements should also be regarded as within the scope of protection of this disclosure. These modifications and improvements will not affect an effect of implementing this application and the practicability of the patent. The scope of protection sought for by this disclosure should be based on the content of the claims, and descriptions of specific embodiments and the like in the specification can be used to explain the content of the claims.

What is claimed is:

1. A salt cavern flow battery system comprising:
a stack, comprising a positive electrode of the stack and a negative electrode of the stack;
a salt cavern, comprising n positive salt caverns for storing positive electrolytes with different valence states separately, and m negative salt caverns for storing negative electrolytes with different valence states separately, wherein n and m are positive integers greater than or equal to 2;
a first closed loop formed by connecting the positive electrode of the stack and the n positive salt caverns in series through a pipeline;
a second closed loop formed by connecting the negative electrode of the stack and the m negative salt caverns in series through a pipeline;
a first pusher arranged in the first closed loop to push the positive electrolytes to flow cyclically in the first closed loop; and
a second pusher arranged in the second closed loop to push the negative electrolytes to flow cyclically in the second closed loop.

2. The salt cavern flow battery system according to claim 1, wherein the first pusher and the second pusher each comprise: a circulation pump arranged in the pipeline and an isolation medium arranged in the salt cavern.

3. The salt cavern flow battery system according to claim 2, wherein a density of the isolation medium is lower than that of the positive electrolyte and the negative electrolyte.

4. The salt cavern flow battery system according to claim 3, wherein the isolation medium comprises one or more of nitrogen and oil.

5. The salt cavern flow battery system according to claim 1, wherein the positive electrolytes comprise a positive active substance and a sodium chloride supporting electrolyte; the negative electrolytes comprise a negative active substance and the sodium chloride supporting electrolyte.

6. The salt cavern flow battery system according to claim 1, wherein each salt cavern is communicated to the ground through two vertical wells.

7. The salt cavern flow battery system according to claim 1, wherein each salt cavern is communicated to the ground by setting a vertical well and an inclined well.

8. The salt cavern flow battery system according to claim 1, wherein each salt cavern is communicated to the ground through a vertical well.

9. The salt cavern flow battery system according to claim 1, wherein the pipeline is made of corrosion-resistant materials.

10. The salt cavern flow battery system according to claim 1, wherein the salt cavern flow battery system is connected with a power supply device for providing electric energy to the salt cavern flow battery system.
